(19) United States
(12) Patent Application Publication
(10) Pub. No.: US 2026/0094106 A1
(43) Pub. Date: Apr. 2, 2026

(54) System

(71) Applicant: Softbank Group Corp., Tokyo (JP)

(72) Inventor: Wataru Nakajima, Tokyo (JP)

(21) Appl. No.: 19/300,063

(22) Filed: Aug. 14, 2025

(30) Foreign Application Priority Data
Aug. 20, 2024 (JP) 2024-138856

(51) Int. Cl. G06Q 10/0639; G06Q 50/04; G06T 7/00

(52) U.S. Cl. CPC G06Q 10/06395; G06Q 50/04; G06T 7/0004; G06T 2207/10016; G06T 2207/30108

(57) ABSTRACT

A system includes a processor that is configured to analyze video data acquired from a monitoring device by using a generation model, generate a work log based on a result analyzed by the generation model, generate a non-fungible token based on the work log, and provide the non-fungible token to a user.

### CROSS-REFERENCE TO RELATED APPLICATION

This application is based on and claims priority under 35 USC 119 from Japanese Patent Application No. 2024-138856 filed on Aug. 20, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In the field of food manufacturing, it has been difficult to ensure transparency and trust regarding the manufacturing process, detect errors or anomalies during production in real time, and provide consumers with reliable information about product origin and process history. Existing systems often lack the ability to integrate real-time monitoring with immutable records that can easily be provided to users, resulting in challenges related to traceability and quality assurance.

### SUMMARY

The present invention provides a system comprising a processor configured to analyze video data acquired from a monitoring device using a generation model, generate a work log based on the analysis results, create a non-fungible token (NFT) based on the work log, and provide the NFT to a user. The processor is further capable of detecting errors or anomalies in the manufacturing process and including product origin information as well as manufacturing process information in the NFT, thereby ensuring transparency, improving reliability, and enhancing traceability for consumers and manufacturers.

“Processor” means a physical or virtual computing device or unit capable of executing instructions and performing data processing tasks as described in the system.

“Video data” means digital images or image sequences captured by a monitoring device such as a camera, representing the observed scenes or processes.

“Monitoring device” means an apparatus or equipment, such as a surveillance camera, designed to observe and capture images or video of a specific area or process.

“Generation model” means an artificial intelligence model, such as a deep learning or other machine learning model, configured to analyze and process input data, particularly video data in this invention.

“Work log” means a chronological record of operations, events, and relevant actions that occurred during a process, especially as detected and generated by the processor based on analyzed video data.

“Non-fungible token” means a unique, blockchain-based digital token representing information and attributes related to a specific product or event, which cannot be replaced with another token.

“User” means an individual or entity who receives the non-fungible token and benefits from the provided information, typically a consumer or client of the manufacturing process.

“Product origin information” means data specifying where a particular product was produced, including geographic location or facility.

“Manufacturing process information” means detailed data regarding the steps, operations, and conditions under which a product was manufactured.

“Error” means an undesirable or abnormal action or event detected during the manufacturing process that deviates from expected standards or procedures.

“Anomaly” means an unexpected or unusual pattern, behavior, or condition detected during the manufacturing process, which may indicate a potential issue or deviation from normal operations.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

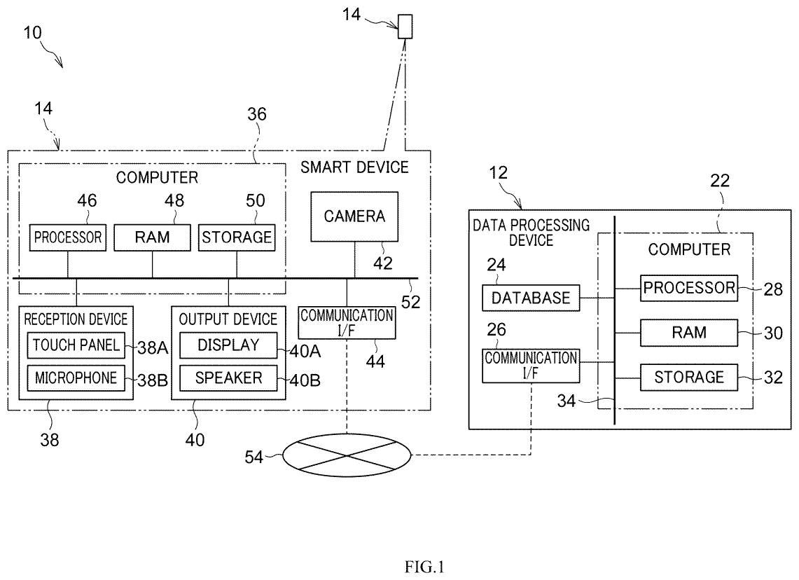

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

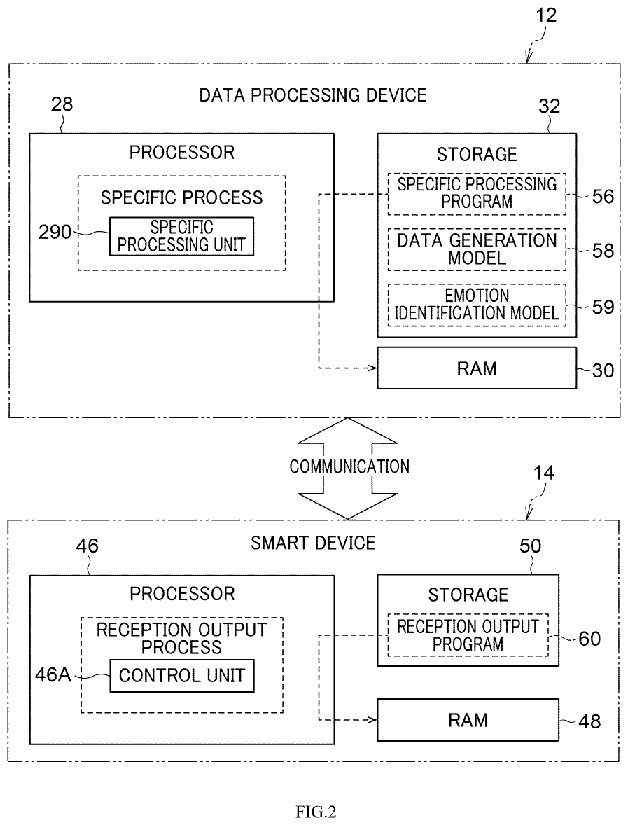

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional manufacturing processes, it is difficult to ensure a reliable traceability and visibility of operations, which results in challenges in guaranteeing product quality and gaining consumer trust. Furthermore, detection of errors and anomalies in the production line often relies on human inspection, leading to delays, omissions, and inadequate responses to defects. There is also a need for a robust, tamper-resistant method to record, certify, and supply detailed information about product origin, processes, and quality assurance to stakeholders and end-users.

The specific processing by the specific processing unit 290 of the data processing device 12 in Example 1 is realized by the following means.

The present invention provides a server comprising a processor configured to preprocess image information acquired from a monitoring device, analyze the preprocessed image information using a generative model mechanism to identify human actions or object states, automatically determine abnormal states or out-of-standard operations based on the identification results, generate information record data in a structured information format including determination results and work content, register the information record data as a non-fungible digital asset on a cryptographically distributed ledger, assign identifier information to the non-fungible digital asset and enable external terminals to refer to it via electronic authentication, and enable a user to acquire and display the non-fungible digital asset on an information terminal. This enables automated, accurate, and verifiable recording and sharing of manufacturing history and quality information, real-time detection and notification of production anomalies, and trusted provision of such structured information to users through secure digital certification.

The term “monitoring device” refers to an apparatus installed within a production environment that captures image or video information in real time for the purpose of observing and recording operations.

The term “image information” refers to visual data, such as videos or photographs, acquired digitally by the monitoring device and representing actions, objects, or states within the observed environment.

The term “data preprocessing” refers to the operations performed on the acquired image information to improve its quality and suitability for subsequent analysis, including but not limited to noise reduction and brightness adjustment.

The term “generative model mechanism” refers to a computational engine based on artificial intelligence, such as a neural network, that processes image information and identifies patterns, actions, or states within the data through machine learning.

The term “human actions” refers to the physical movements or operations performed by individuals within the production environment, as captured in the image information.

The term “object states” refers to the physical conditions or properties of items or products being handled within the production environment, as observable from the image information.

The term “abnormal states” refers to situations, events, or actions identified by the generative model mechanism which deviate from established standards, operational procedures, or quality requirements.

The term “out-of-standard operations” refers to processes, movements, or states occurring in the production environment that fail to meet predefined thresholds or specifications.

The term “information record data” refers to sets of data that include the results of identification, classification, judgments, and related content regarding events, processes, or anomalies in a structured information format.

The term “structured information format” refers to a machine-readable arrangement or schema for organizing data, such as formats based on JSON, XML, or similar, to facilitate storage, retrieval, and interpretation.

The term “non-fungible digital asset” refers to a unique digital certificate or record registered on a cryptographically distributed ledger, which cannot be replaced or interchanged, and is used to verify and trace detailed information about an article or event. The term “cryptographically distributed ledger” refers to a decentralized recording system that maintains data entries in a tamper-resistant and verifiable manner using cryptographic techniques, such as a blockchain.

The term “identifier information” refers to data elements, such as codes or digital signatures, that uniquely distinguish and enable retrieval of a corresponding non-fungible digital asset.

The term “external terminal” refers to an information processing device, such as a computer, workstation, or smart device, located outside the server system, which accesses or interacts with the server through a network connection.

The term “electronic authentication” refers to the procedure by which the system verifies the identity or authority of an external terminal or user attempting to access a non-fungible digital asset.

The term “information terminal” refers to a user-operated computing device capable of retrieving and displaying data, such as a smartphone, tablet, computer, or other display-enabled apparatus.

The term “user” refers to an individual or entity that accesses, acquires, or utilizes information or digital assets provided through the system.

The system may be implemented using a server equipped with a processor, storage, and communication interfaces. The server may be connected to one or more monitoring devices, which can be general-purpose imaging hardware such as network cameras, industrial cameras, or embedded vision modules. The server may also be connected to databases and blockchain nodes for data storage and authentication purposes. Terminal devices may include personal computers, tablet computers, or smart devices operated by manufacturing staff or management. User devices may include smartphones with imaging and networking capabilities.

The server can receive video or image information in real time from the monitoring device within, for example, a manufacturing facility. The server performs data preprocessing using general image processing software, such as an open-source image processing library. This processing may include noise removal using Gaussian filtering and brightness adjustment with histogram equalization, ensuring that the images are suitable for further analysis.

Following preprocessing, the server utilizes a generative AI model mechanism, which may be implemented using a deep learning framework such as TensorFlow or PyTorch. This model analyzes each frame or segment of the preprocessed image information to identify events such as human actions, object states, or workflow steps. Based on predetermined standards or behavioral templates, the model may automatically detect deviations or anomalies, such as out-of-standard operations, process inconsistencies, or defects.

When such events or results are identified, the server generates information record data, which may include time stamps, description of detected anomalies, affected objects, and recommended actions. This data is structured in a machine-readable format such as JSON or XML. The server then registers this structured information as a unique, non-fungible digital asset on a cryptographically distributed ledger, for example, a blockchain platform. The server assigns identifier data to each digital asset to ensure uniqueness and traceability.

The server makes the digital asset accessible by electronic authentication from registered external terminals or information terminals. A user, after acquiring a product, may use a smartphone or other information terminal to scan a code, such as a QR code, associated with the product. The terminal sends a request to the server or blockchain node and retrieves the digital asset, where the user can view the manufacturing process, origin, and inspection record of the product.

As a concrete example, the monitoring device may capture an incident in which a worker places an incorrect label on a product during packaging. The server preprocesses and analyzes the image data, identifies the action as abnormal by comparison with standard procedures, and logs the event as a data record. The information, including timestamps, object identification, and corrective suggestions, is formatted as structured data and registered as a non-fungible digital asset. A user may, after purchasing the product, scan the product's code and receive all recorded manufacturing and quality information to verify the product's authenticity and production history.

Examples of prompt sentences that users or operators may input to the system include the following:
Show me the manufacturing record for the purchased product.
Display the quality inspection results recorded in the digital certificate.
Stream the real-time monitoring video feed.
Summarize any anomalies detected in today's production.
Retrieve and show digital certificate data for this item.

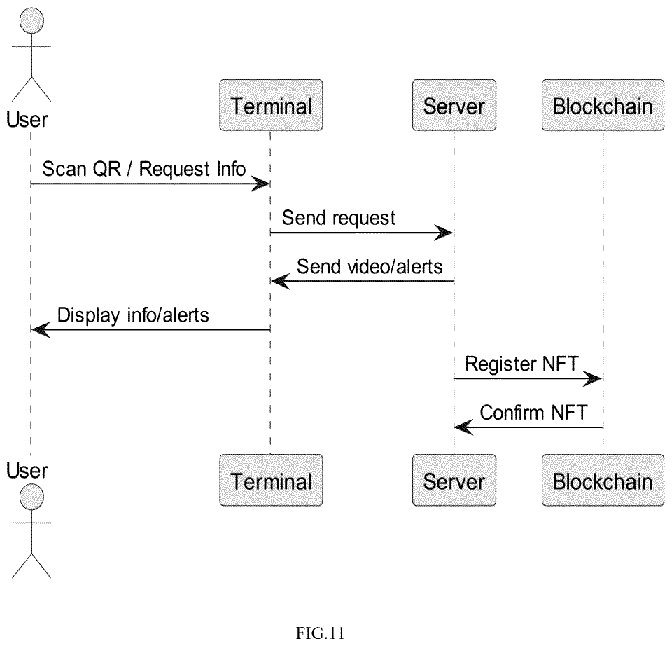

The following describes the processing flow using FIG. 11.

### Step 1

The server receives real-time video data from the monitoring device installed in the manufacturing facility. As input, the server obtains raw streaming video files or frames. The server writes the incoming video data to its local storage, organizing the frames by time and camera source. The output of this step is a file or set of files in which the raw video data is stored for further processing.

### Step 2

The server pre-processes the video data using an image processing library. As input, the server utilizes the raw video files saved in the previous step. The server applies noise reduction filters, such as Gaussian blur, and adjusts brightness and contrast of each frame for normalization. The processed frames are saved as new files. The output is a sequence of preprocessed, cleaned video frames ready for AI analysis.

### Step 3

The server analyzes the preprocessed video frames using a generative AI model built with a machine learning framework. As input, the server takes the cleaned frames generated from the previous step. The server runs the AI model inference, which classifies actions, detects human operation, and identifies product conditions within each frame. The output is an event list, specifying the type and location of detected actions and any potential anomalies.

### Step 4

The server detects abnormal events by comparing the classified actions and product states to predefined standard operation patterns. The input is the event list created from the AI analysis. The server uses rule-based logic or learned threshold values to identify frames or sequences that contain out-of-standard operations or product defects. The output is a list of anomalies, each with a timestamp, description, and affected object.

### Step 5

The server generates a structured information record using the detected anomalies and relevant metadata. As input, the server uses the anomaly list produced in the previous step along with associated operational metadata (such as product ID and operator ID). The server creates a JSON or XML formatted record containing detailed descriptions, timestamps, and suggested corrective actions. The output is a machine-readable file or message containing the structured event log.

### Step 6

The server registers the structured information record as a non-fungible digital asset on a cryptographically distributed ledger. As input, the server uses the structured event log created in the previous step. The server formats the log for compatibility with the blockchain platform, generates a unique identifier, and sends a transaction to register the asset as a non-fungible token. The output is a record stored on the distributed ledger, associated with a unique digital asset identifier.

### Step 7

The terminal receives the real-time video stream and server notifications. As input, the terminal obtains the processed video and any event or anomaly alerts pushed by the server. The terminal displays the live video through player software, and shows alerts as pop-up notifications. The output is a real-time visual display for the operator, including immediate feedback when anomalies occur.

### Step 8

The user obtains access to the non-fungible digital asset via an information terminal. As input, the user scans a product code, such as a QR code, using a dedicated application on a smartphone or computer. The terminal sends a request to the server or blockchain node, referencing the product's digital asset identifier. The output is a presentation on the device, displaying detailed manufacturing and inspection data retrieved from the digital asset.

### Step 9

The user reviews the manufacturing and quality history displayed by the app or terminal. As input, the user interacts with the presented information and may enter additional queries or prompt sentences, for example, “Show all anomalies detected during packaging.” The system processes the query and provides the relevant information on screen. The output is user-verified product provenance and quality information, enabling trust and transparency.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In recent years, efficient management of production quality and plant security in manufacturing environments has become an increasingly important challenge. Conventional systems are limited in their ability to detect anomalies in real time and to provide immediate response actions. Furthermore, providing detailed and trusted production process information to end users remains difficult, as existing systems often lack transparency and reliable means for product authentication and traceability. Additionally, current approaches do not capture user satisfaction or emotional feedback in a manner that can be integrated into continuous improvement cycles for quality and service.

The specific processing by the specific processing unit 290 of the data processing device 12 in Application Example 1 is realized by the following means.

The present invention provides a server comprising a processor configured to analyze information data acquired from a monitoring apparatus using a generative artificial intelligence model, generate time-series information record data based on the analysis results, generate electronic authentication information (such as a non-fungible token) incorporating provenance and quality data, register the authentication information in a distributed ledger, provide the information to a user, display relevant data and alerts on terminal devices in real time, and process emotion information collected from the user in order to generate feedback for quality or service improvement. This enables real-time anomaly detection, immediate response notification, secure and transparent product authentication, enhanced process traceability, and continuous feedback-driven improvement in manufacturing and distribution environments.

The term “monitoring apparatus” refers to an electronic device or system configured to acquire information data, such as video, audio, or sensor signals, from a target environment for the purpose of observation or surveillance.

The term “generative artificial intelligence model” refers to a computer-implemented model utilizing machine learning or deep learning techniques, including neural networks, to analyze input data and generate output, such as detection of events, anomalies, or classification results.

The term “information data” refers to digital data acquired from the monitoring apparatus, including but not limited to visual, audio, or sensor-based data representing the operational state of a monitored environment.

The term “time-series information record data” refers to structured data generated by the processor, representing a chronological record of events, actions, or detected states within a monitored process or environment.

The term “electronic authentication information” refers to digital data, such as a non-fungible token or other cryptographically secured record, that uniquely identifies and certifies the provenance, quality, or process history of an object or event.

The term “distributed record management device” refers to a computing system or network, such as a blockchain or distributed ledger, in which data entries are maintained in a decentralized and tamper-resistant manner.

The term “user” refers to an individual or entity that receives, reviews, or interacts with the electronic authentication information, and may also provide feedback or emotional information related to the authenticated object or process.

The term “emotion information” refers to digital data representing the emotional state, reaction, or feedback of a user, which may be acquired through analysis of biometric signals, interactions, or explicit feedback.

The term “management information” refers to data generated based on analysis of emotion information, used to provide feedback for improving processes, products, or services within the system.

The term “terminal device” refers to a user-accessible hardware device, such as a computer, smartphone, tablet, or display system, that presents information data and analysis results and receives alerts from the processor in real time.

The term “anomaly detection” refers to the process of identifying states, events, or conditions within the monitored data that deviate from expected or predefined operational norms.

The system comprises a server, one or more monitoring apparatuses, one or more terminal devices, and user-side devices. The main processing is performed by the server, which is equipped with a processor, memory, non-volatile storage, communication interfaces, and, optionally, a graphics processing unit (GPU) suitable for machine learning computations. The monitoring apparatus may include network cameras, environmental sensors, or other data acquisition units capable of capturing visual, audio, or process-related data from a production environment.

The server operates on a general-purpose computing device, which may be implemented using a hardware server such as a rack-mounted computer or a cloud-computing platform. For the software environment, the server may utilize an operating system such as Ubuntu Server or Windows Server, and run software libraries such as OpenCV for image processing tasks, TensorFlow or PyTorch for the generative artificial intelligence model, and blockchain middleware like a Web3 interface for interaction with distributed ledgers. The server stores captured information data in a database, such as a relational database management system or a file storage system, and may use a blockchain platform, such as an Ethereum-compatible network, to handle electronic authentication information (for example, minting non-fungible tokens).

The server is configured to acquire information data continuously from the monitoring apparatus via secure network protocols (for example, RTSP for video, HTTP/S for sensor data). The server preprocesses the incoming data by applying noise reduction, image enhancement, or other cleaning algorithms using OpenCV. The generative artificial intelligence model, implemented as a deep learning neural network trained in TensorFlow or PyTorch, is then used to analyze each segment of the input data and output classification results, such as anomaly detection or process step validation.

Based on the analysis results, the server compiles time-series information record data, which represent the operational activities or detected events in chronological order.

These records are aggregated and used to generate electronic authentication information, for example, by encoding them as a non-fungible token on a distributed ledger. The server interacts with the distributed record management device (blockchain) by utilizing middleware and smart contracts to ensure immutability and traceability of the product or process information.

The server is further configured to provide the generated electronic authentication information to the user, which may include communication through email, QR codes, or integration with a user's digital wallet application. The server may also receive emotion information from the user, collected through a mobile application that uses device sensors (such as a camera or microphone) and embedded emotion recognition software (such as a mobile version of Affectiva or a TensorFlow Lite model). The server processes the received emotion information to generate management information that supports quality improvement or enhances user experience.

Terminal devices, which may include computers, tablets, or dedicated displays located in the production environment, are equipped to receive real-time data and notifications from the server. They display live information and deliver alerts in the event of anomalies, enabling prompt response by operators or supervisors.

Users, including end consumers or administrators, can access the electronic authentication information through personal devices (such as smartphones or computers) and verify the provenance, process, and quality data registered on the distributed ledger. By leveraging the authentication information and process transparency, users gain confidence in the product's origin and history.

As a concrete example, suppose a user purchases a high-value agricultural product. The server tracks the entire process, records critical events via the AI model, generates a non-fungible token that certifies the production and inspection history, and registers this information on a blockchain network. When the user receives the product, the user scans a code on the product package, reviews the process record, and optionally submits emotion feedback via an app. If high user satisfaction is detected, the server may trigger the delivery of thank-you messages or product recommendations.

An example of a prompt sentence used for the generative AI model in this embodiment is as follows:

“Acquire real-time video frames from the factory's network camera, preprocess images with OpenCV for noise reduction and edge detection, and input them into the YOLOv5 model for worker and product anomaly detection. Log anomalies with precise timestamps, generate an NFT containing the operation history, and mint this NFT on Ethereum via a smart contract. If a user later accesses the NFT, analyze their facial expressions with Affectiva SDK to assess satisfaction.”

This embodiment, involving the integration of information data analysis, generative artificial intelligence models, electronic authentication via distributed ledgers, and emotion feedback from users, facilitates real-time quality and security management, transparent process traceability, and feedback-driven process improvement across a variety of application fields.

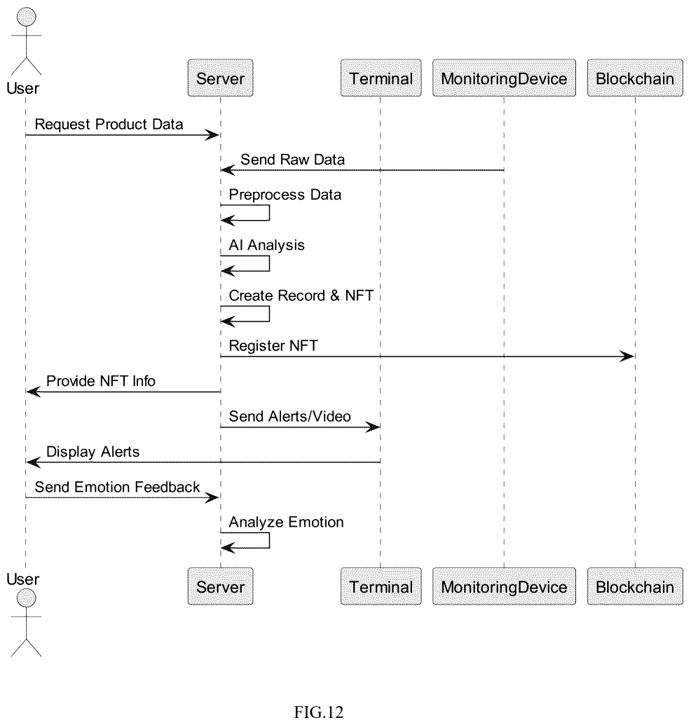

The following describes the processing flow using FIG. 12.

### Step 1

The server acquires raw information data from the monitoring apparatus installed in the production environment.

Input: Video streams or sensor data from the monitoring apparatus.

Output: Temporarily stored raw information data on the server.

The server establishes a network connection to each monitoring apparatus, receives real-time video frames or sensor readings, and stores these data packets in designated storage locations with associated timestamps.

### Step 2

The server preprocesses the acquired information data to enhance quality for subsequent analysis.

Input: Raw information data from storage.

Output: Preprocessed information data.

The server applies noise reduction filters, performs image enhancement such as contrast adjustment, carries out frame extraction, and formats the data as required by downstream analysis tools. This may use image processing libraries such as OpenCV.

### Step 3

The server analyzes the preprocessed information data using a generative artificial intelligence model.

Input: Preprocessed information data.

Output: Analysis results including detected process steps, events, anomalies, or errors.

The server loads a trained machine learning model (for example, a neural network created with TensorFlow or PyTorch), processes each preprocessed frame, and determines the presence of abnormalities, classifies worker actions, or validates process steps. The server logs each significant result with a timestamp for later use.

### Step 4

The server generates time-series information record data based on the analysis results.

Input: Analysis results from the AI model.

Output: Structured time-series record data.

The server aggregates all detected events and process step information in chronological order, producing structured records (such as in JSON or CSV format) that reflect the operational sequence and any anomalies detected.

### Step 5

The server generates electronic authentication information, such as a non-fungible token, from the time-series record data and registers it on a distributed ledger.

Input: Time-series record data.

Output: Electronic authentication information stored in and retrievable from the distributed ledger.

The server formats the record data, creates a digital asset (NFT), and interacts with a blockchain system using middleware (such as a Web3 interface) to register this asset immutably, which includes provenance, process, and quality data.

### Step 6

The server provides the electronic authentication information to the user.

Input: Electronic authentication information from the blockchain.

Output: User-side access to certification data, such as through QR codes, digital wallets, or mobile apps.

The server communicates the authentication information to the end user by generating a QR code on product packaging, sending an electronic message, or making the data accessible through a digital wallet interface.

### Step 7

The terminal displays information data and server analysis results in real time, and notifies operators immediately in case of detected anomalies.

Input: Real-time information data and alerts from the server.

Output: Live displays and real-time alerts on the terminal device.

The terminal receives video streams and alert signals from the server, displays the live feed, and produces visual or audible alerts if an error or abnormality is detected, enabling prompt onsite response by operators.

### Step 8

The user accesses the authentication information and may provide emotion information through their device.

Input: Electronic authentication information and user emotion data (if provided).

Output: Verification of process data by the user and, optionally, emotion feedback sent to the server.

The user views production and quality records through an app or web portal and, if emotion feedback is enabled, consents to emotion recognition via device sensors, which submit emotion information back to the server.

### Step 9

The server processes the received emotion information from the user to generate management information for quality and service improvements.

Input: Emotion information from user devices.

Output: Management information and potential adjustments to processes or customer service.

The server analyzes the user's emotion data (using a recognition engine) and aggregates feedback to create reports or trigger automatic service responses, improving product quality and user experience over time.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional monitoring systems in manufacturing processes are limited in that they provide only visualized data and basic anomaly detection, but lack mechanisms for providing consumers with detailed, trustworthy information about production processes and product provenance. Moreover, these systems do not allow real-time evaluation of consumer satisfaction or effective integration of consumer feedback for continuous service improvement. There is an increasing demand for a system that enables higher transparency, trust, and engagement between manufacturers and consumers by leveraging advanced data processing, traceability through digital assets, and emotion analysis regarding product satisfaction.

The specific processing by the specific processing unit 290 of the data processing device 12 in Example 2 is realized by the following means.

The present invention provides a server comprising a processor configured to preprocess image data from a monitoring device, analyze the preprocessed data using a deep learning model, generate process record information, create and register a unique digital asset on a distributed ledger, provide the digital asset to a user via an information terminal, analyze user evaluation or emotion data using natural language processing technology to determine satisfaction, and offer additional information or benefits based on the satisfaction score. This enables real-time monitoring, transparent product traceability, automatic anomaly detection, digital asset-based information distribution, and dynamic user satisfaction assessment, thereby increasing product trustworthiness and consumer engagement.

The term “monitoring device” refers to an apparatus configured to capture and transmit image data representing operations, processes, or environments within a manufacturing facility or other designated area.

The term “image data” refers to digital representations of visual information obtained from a monitoring device, including, but not limited to, video streams or still frames.

The term “preprocess” refers to operations performed on raw image data in order to enhance its quality and make it suitable for subsequent analysis, such as noise reduction, normalization, and frame extraction.

The term “deep learning model” refers to a computational model utilizing multi-layered artificial neural networks designed to analyze complex data, such as images, and extract features or detect patterns, including anomalies or specific actions.

The term “process record information” refers to data generated based on the analysis of image data, documenting details of operations, detected anomalies, product handling, and other relevant manufacturing process events.

The term “unique digital asset” refers to a non-fungible, digitally recorded entity that uniquely represents and encapsulates process record information, product provenance, and related data on a distributed ledger.

The term “distributed ledger” refers to a decentralized database system that maintains a continuously growing record of transactions or digital assets across a network of computers, ensuring data integrity and traceability.

The term “information terminal” refers to an electronic device, such as a smart device, workstation, or other computing unit, capable of receiving, displaying, or transmitting digital content to a user.

The term “user evaluation information” refers to data provided by a user, including ratings, feedback, comments, or other subjective assessments regarding a product or service.

The term “emotion information” refers to data reflecting a user's emotional state or sentiment, which can be derived from explicit feedback, linguistic analysis, or other suitable means.

The term “natural language processing technology” refers to computational techniques and algorithms for analyzing, understanding, and extracting meaning from human language data, including sentiment analysis and emotion detection.

The term “satisfaction score” refers to a quantified value representing the level of user satisfaction as determined by analysis of evaluation information or emotion information.

The term “production location information” refers to data identifying the geographical or facility-based origin of a product, including manufacturing site, farm, or other points of provenance.

The term “manufacturing process information” refers to data describing the sequential steps, procedures, or operations involved in producing a product.

The term “quality management information” refers to data regarding the assessment, testing, or validation of a product to ensure compliance with predefined quality standards.

The preferred embodiment of the invention will now be described in detail. The server is implemented as a computing device equipped with a processor, memory, data storage, and network communication interfaces. The server executes software components comprising video data acquisition modules, data preprocessing modules, a deep learning-based generative AI model, a distributed ledger interface, and a natural language processing module. The server may be deployed using general-purpose hardware such as x86 or ARM-based processors, and commercially available cloud platforms may also be utilized. Surveillance video data is acquired from monitoring devices such as network cameras installed on a production line or within a facility. These cameras may operate using protocols such as RTSP (Real-Time Streaming Protocol). The server receives the video data, which may be temporarily stored in cloud object storage such as a general-purpose cloud storage service. The server preprocesses the raw video data to improve quality and extraction accuracy. This preprocessing typically involves filtering operations (such as Gaussian blur or average filters) and frame extraction at defined intervals. This preprocessing is preferably implemented using the OpenCV library in Python or a similar computer vision toolkit.

The preprocessed video data is then input into a generative AI model, such as one constructed with TensorFlow or PyTorch frameworks. The server executes the generative model to analyze operations performed in the video, to detect events including standard process actions and operational anomalies or errors. The model's output includes labeled actions, anomaly types, and metadata tagging specific frames as relevant for further inspection.

Based on the model's analysis, the server automatically generates structured process record information describing each operation and any detected anomalies within the process sequence. This record is stored in a high-throughput, scalable database, for example, a NoSQL database such as MongoDB.

To securely document process history, the server generates a unique digital asset—specifically, a non-fungible token—using distributed ledger (blockchain) technology. The process record, together with information such as product origin, manufacturing steps, and quality inspection results, is incorporated into the metadata of the digital asset. The server uses a distributed ledger interface such as Web3.py to register the digital asset as a transaction on a public or private blockchain platform compatible with ERC-721 or equivalent standards.

The server provides the unique digital asset to the user via an information terminal, which may be a smart device, workstation, or mobile application. Users can access, view, and verify the process data, provenance information, and inspection results using typical blockchain viewers or dedicated application software.

The user has the ability to submit evaluation information or feedback, such as textual reviews or comments about their satisfaction with the product or process. The server extracts this data and processes it using natural language processing technology. Widely used libraries for this purpose may include spaCy, NLTK, or equivalent text analysis tools. Emotion information extracted from the user's feedback is quantified as a satisfaction score.

Depending on the satisfaction score, the server dynamically provides additional information or benefits to the user. For example, if the score is high, the user may receive an online coupon, additional product background, or a digital certificate. If the score is low, the server may prompt the user for more detailed feedback or offer support resources.

A concrete example includes a user purchasing a premium food product. The user, via a mobile application, requests and receives a unique digital asset associated with that product. The user accesses detailed history including origin, manufacturing process, and inspection results. After consumption, the user submits feedback such as “The product was fresh and perfectly packed.” The server, analyzing the feedback using natural language processing, determines a high satisfaction score and rewards the user with a product recipe or discount.

An example of a prompt sentence suitable for the generative AI model is as follows:

“Design a program to analyze video data acquired from factory monitoring devices, visualize the manufacturing process, and detect errors in real time. Output should include process steps, detected anomalies, with logging and alerting functionality.”

Through these integrated features and procedural steps, this embodiment facilitates automated, transparent monitoring and traceability, enhances user trust, and enables effective consumer engagement using advanced AI and blockchain technologies.

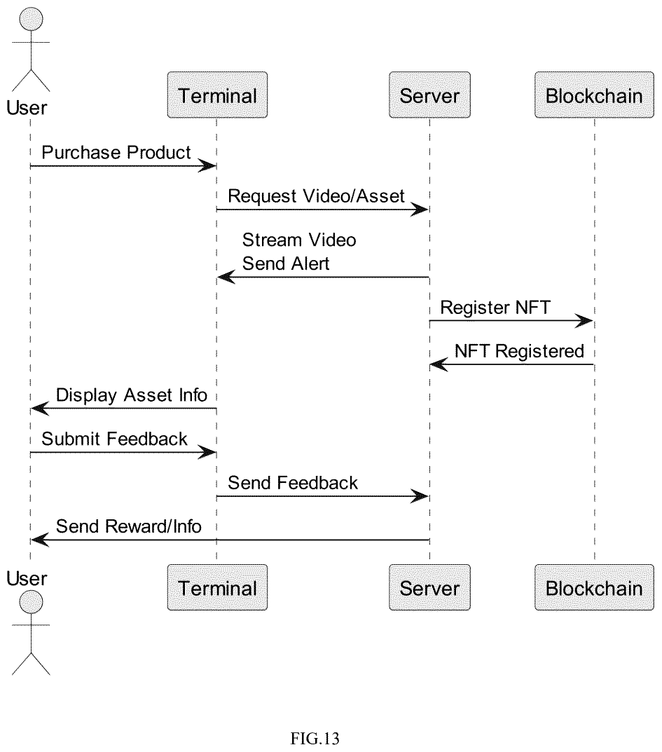

The following describes the processing flow using FIG. 13.

### Step 1

The server receives image data as a real-time video stream from monitoring devices installed on a production line.

Input: Raw video stream from monitoring device.

The server buffers the incoming video using an RTSP client, segments the stream as individual video files, and stores these files in cloud storage.

Output: Raw video files stored in cloud storage.

### Step 2

The server performs preprocessing on the raw video files to prepare them for analysis.

Input: Raw video files from cloud storage.

The server uses a computer vision library such as OpenCV to reduce noise, convert video to suitable formats, and extract frames at regular intervals. The preprocessing generates a series of clean image frames representing the production process.

Output: Preprocessed image frames.

### Step 3

The server analyzes the preprocessed image frames using a generative AI model implemented with a deep learning framework.

Input: Preprocessed image frames.

The server loads image frames into the AI model, which detects worker activities, standard process steps, and any operational anomalies such as mishandling, missing steps, or the presence of foreign objects. The model outputs labeled events and anomaly metadata.

Output: Labeled activity events and anomaly detection results.

### Step 4

The server creates process record information based on the output of the AI model.

Input: Labeled activity events and anomaly detection results.

The server compiles a structured log containing timestamps, detected actions, and detailed descriptions of any anomalies. The log is stored in a database for traceability.

Output: Structured process log with time-ordered records of all detected events.

### Step 5

The server generates a unique digital asset using blockchain technology based on the process record information and related data.

Input: Structured process log, product provenance information, and quality inspection data.

The server formats this information as metadata, creates a non-fungible token using a blockchain library, and registers the token on a distributed ledger.

Output: Unique digital asset (NFT) registered on a blockchain.

### Step 6

The terminal receives notifications and real-time streaming video from the server for monitoring purposes.

Input: Real-time video stream and anomaly notifications from the server.

The terminal uses software such as a video player or custom interface to display the video and provide audible or visual alerts if anomalies are reported.

Output: Real-time production monitoring and alert display on the terminal.

### Step 7

The user acquires and views the unique digital asset associated with the purchased product through an information terminal such as a smartphone or computer.

Input: Unique digital asset provided by the server.

The user employs an application or blockchain viewer to inspect the asset and verify process, provenance, and quality details.

Output: Displayed product history and verification result on the user's device.

### Step 8

The user submits feedback or evaluation about the product or process via the information terminal.

Input: User feedback text or evaluation data.

The server processes this data using a natural language processing module, analyzes the user's emotional sentiment or satisfaction level, and determines a satisfaction score.

Output: Quantified satisfaction score and, if applicable, an automated response or reward to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional systems for quality management and process monitoring, there are limited methods to provide consumers or management targets with directly trustworthy and transparent information regarding the production process of articles. Furthermore, it is difficult to acquire and evaluate the real-time emotional feedback and satisfaction of users regarding products or services, thereby preventing rapid and effective improvement of product quality and service level. Additionally, there is a lack of efficient mechanisms for ensuring the reliability and traceability of process data using objective, tamper-resistant technologies.

The specific processing by the specific processing unit 290 of the data processing device 12 in Application Example 2 is realized by the following means.

The present invention provides a server comprising a processor configured to preprocess measurement data acquired from an external device, analyze the preprocessed measurement data using a generative information processing model, generate management information as time-series data, create a uniquely identifiable electronic record based on the management information, register the electronic record on a distributed ledger, provide the record to a management target, acquire and analyze behavioral and emotional information of the management target, and evaluate and store an evaluation value based on the emotional information. This enables seamless creation and distribution of reliable, traceable process information as electronic records, and real-time evaluation of user satisfaction, allowing rapid feedback cycles and improvement of product and service quality.

The term “processor” refers to a computation unit or hardware device capable of executing instructions for data processing and system control.

The term “measurement data” refers to any type of data obtained from sensing devices, including but not limited to images, video, audio, or sensor readings, that represent the status or condition of a physical environment or process.

The term “external device” refers to any apparatus or equipment, such as sensors, cameras, or monitoring instruments, situated outside the processor and used for acquiring measurement data.

The term “preprocessing” refers to operations performed on raw measurement data, such as noise reduction, normalization, segmentation, or format conversion, to improve data quality and readiness for subsequent analysis.

The term “generative information processing model” refers to a computational model, typically utilizing artificial intelligence or machine learning, that analyzes input data and outputs inferences, categorizations, or predictions related to process events or object conditions.

The term “management information” refers to aggregated or organized records that document the sequence of operations, states, results, or detected anomalies within a process, formatted as time-series data.

The term “electronic record” refers to a digital file or dataset that is uniquely identifiable and contains management information for tracking, verification, or ownership purposes.

The term “distributed ledger” refers to a decentralized database technology, such as blockchain, where electronic records are immutably stored, synchronized, and accessible by authorized parties.

The term “management target” refers to an entity such as a user, operator, consumer, or administrator who is the recipient of information and/or evaluation in the system.

The term “behavioral information” refers to data representing physical actions, usage patterns, or operational activities of a management target, often acquired through monitoring or sensing devices.

The term “emotional state” refers to the current psychological or emotional condition of a management target, as estimated from data sources such as facial expressions, physiological signals, or behavioral patterns.

The term “evaluation value” refers to a computed score or quantitative assessment representing the satisfaction level or feedback of a management target, based on interpreted behavioral or emotional information.

The term “generation location information” refers to data indicating the origin or place where an article or process event occurred.

The term “process history information” refers to an ordered record of events, operations, or transformations that an article or system has undergone from origin to final state.

### Embodiment for Implementing the Invention

The invention can be implemented as a system comprising a server equipped with a processor, storage, network communication modules, and appropriate software components. The server is connected to one or more external devices, such as cameras, sensors, or other data acquisition instruments, which capture measurement data from a physical facility, manufacturing site, or retail environment.

The server receives measurement data, for example, video streams or sensor signals, from the external devices via network protocols. The measurement data is stored temporarily in the server's storage, such as a solid-state drive or a network-attached storage system.

The server applies preprocessing operations to the raw measurement data to improve its quality and suitability for analysis. For instance, image data may be processed using software libraries such as OpenCV for denoising, normalization, and frame extraction. Other types of data, such as temperature or vibration data, may be normalized or filtered using relevant data processing software.

The processed data is then analyzed by the server using a generative information processing model. The generative AI model, implemented with software frameworks such as TensorFlow or Keras, is configured for tasks such as action recognition, anomaly detection, or event classification depending on the system's application. The AI model receives the preprocessed data and produces predictions or classifications, for example, “assembly operation detected,” “abnormal vibration,” or “no error.”

The server compiles the analysis results into management information, which is structured as time-series data. This information documents the sequence and outcome of operations, states, and any detected anomalies. The management information is serialized in a digital format such as JSON or CSV and stored in a secure database within the server. Subsequently, the server generates a uniquely identifiable electronic record based on the management information. For traceability and security, this electronic record is registered on a distributed ledger, for example, a blockchain platform such as Ethereum or Hyperledger Fabric. The server uses relevant APIs to register the electronic record, effectively creating an immutable, verifiable record that can be linked to a particular article or process.

The server provides access to the registered electronic record to a management target, such as a user, consumer, or administrator. The user can interact with a web application or smartphone application to view the electronic record. The application may use a blockchain explorer or a dedicated user interface for displaying the process history, origin information, and other management details.

In addition, the server is configured to acquire and analyze behavioral information and emotional state data from the management target. For example, when a user views the electronic record on a device, the device may activate a camera (with user consent) to capture video or image data of the user's face. The server receives this data and applies emotion analysis using emotion recognition engines or APIs, such as Affectiva or a commercial emotion recognition service.

The server calculates an evaluation value, such as a satisfaction score or emotional feedback metric, based on the analyzed emotional state data. This evaluation value is stored and utilized to improve products or services, or to offer personalized notifications or incentives to users.

As a specific example, in a manufacturing environment, the server receives video data from industrial cameras, processes the video by removing noise, and analyzes each frame with a generative AI model trained for assembly line monitoring. The server generates a digital history of all assembly steps and detected errors, and registers this history as an electronic record on the blockchain. When a consumer purchases the manufactured product, the server transfers access to the related electronic record, enabling the consumer to verify manufacturing authenticity and quality. If the consumer views their product's process record through a mobile app, the consumer's emotional response can be analyzed to measure satisfaction, and follow-up actions can be taken accordingly.

An exemplary prompt sentence for the generative AI model used in emotion analysis is as follows:

“Given consecutive frames from user camera video, analyze each and classify the emotion (joy, anger, surprise, dissatisfaction). Output the dominant emotion with a confidence score at 1-second intervals.”

The invention is thus realized by integrating hardware such as servers, sensors, and user devices, with software components including data processing libraries, generative AI models, distributed ledger technologies, and emotion analysis APIs. The combination enables comprehensive acquisition, trustworthy recording, transparent presentation, and feedback-driven improvement of process and quality data.

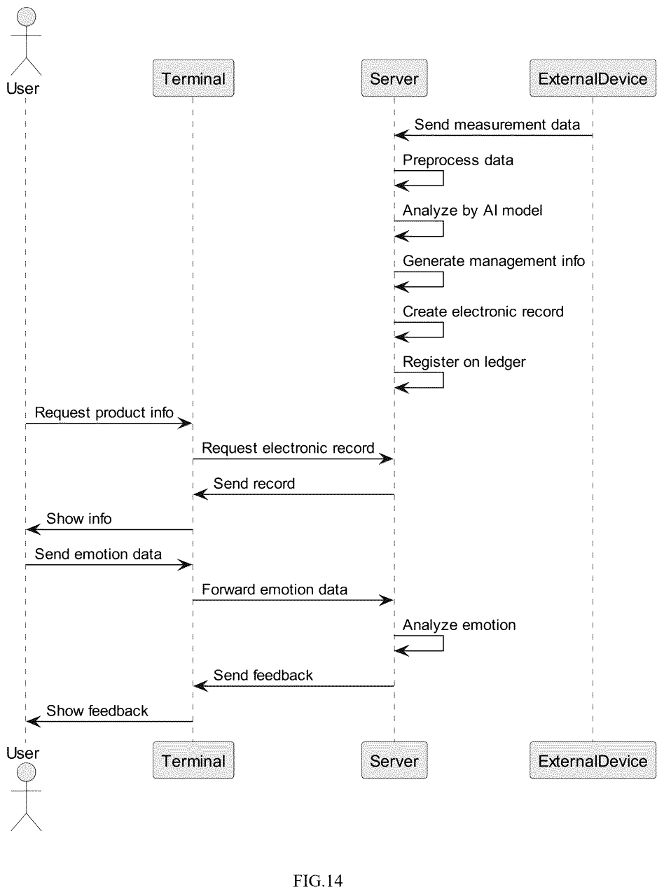

The following describes the processing flow using FIG. 14.

### Step 1

The server receives measurement data from external devices such as cameras or sensors via a network interface. The input for this step is the raw data stream (for example, video files or sensor logs) coming from the external device. The server saves the incoming data in a designated storage area on its local disk or network-attached storage. As a concrete operation, the server activates a data reception service and continuously writes the raw data stream to timestamped files.

### Step 2

The server preprocesses the stored raw measurement data using data processing software such as OpenCV or a numerical computing library. The input is the raw measurement data saved in storage. The server applies operations such as noise reduction, normalization, and, in the case of video data, frame extraction, to improve data quality and prepare it for analysis. The output is a set of cleaned and normalized data files or segmented video frames. For instance, the server may process each raw video file by applying a denoising filter and splitting it into individual images.

### Step 3

The server analyzes the preprocessed data using a generative AI model implemented with software frameworks such as TensorFlow or Keras. The input for this step is the set of preprocessed data files. The server runs the generative AI model to extract relevant features and classify events, such as detecting specific operations, identifying anomalies, or recognizing predefined patterns. The output is an annotated dataset or event classification results. For example, the server may process image frames to detect “assembly operation,” “error,” or “normal operation” tags for each time period.

### Step 4

The server generates management information in the form of time-series data based on the AI model's results. The input is the annotated or classified data produced by the AI model. The server organizes this information into structured digital records, such as time-stamped event logs or status reports, and stores them in a database. The output is a management information file or record that describes the sequence of operations and detected issues. For example, the server creates entries with the time, operation, and error status for each process step.

### Step 5

The server creates a uniquely identifiable electronic record based on the management information. The input is the management information generated in the previous step. The server packages this data into an electronic record format, incorporating identifiers, metadata, and process history. The output is the electronic record ready for distributed ledger registration. The server generates a unique identification code and digital signature for this record as a concrete operation.

### Step 6

The server registers the created electronic record on a distributed ledger, such as a blockchain, using smart contract interaction. The input is the electronic record containing all relevant process data. The server sends a transaction request to the distributed ledger network, uploads the electronic record, and waits for confirmation. The output is a verified, immutable record with a unique ledger identifier. The server stores the mapping between the product and the distributed ledger record in its internal database.

### Step 7

The server provides access to the registered electronic record to the management target, such as the user, via a web or mobile application. The input is a request from the user to view or verify the record. The server verifies the user's authorization and transmits the electronic record details to the user's device. The output is a user interface showing the process history and verification data. For example, the server responds to a user's app query and displays all production steps associated with a purchased product.

### Step 8

The server acquires behavioral and emotional information from the user through the user's device, such as a camera or sensor. The input is live behavioral or facial image data sent from the user device when viewing the electronic record. The server analyzes this input using an emotion recognition engine or generative AI model. The output is an emotional classification or satisfaction score for the user. For instance, the server processes the incoming video, detects a “happy” or “disappointed” emotion, and saves the result in the user's profile.

### Step 9

The server utilizes the evaluated emotional information to update the database, provide feedback, or trigger automated responses. The input is the satisfaction score or emotional classification obtained in the prior step. The server may store the value for analytics, notify administrators, or send automated notifications, rewards, or follow-up questions to the user. The output is an updated user record and, if appropriate, a message or action delivered to the user, such as a thank-you message or a survey for dissatisfied users.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

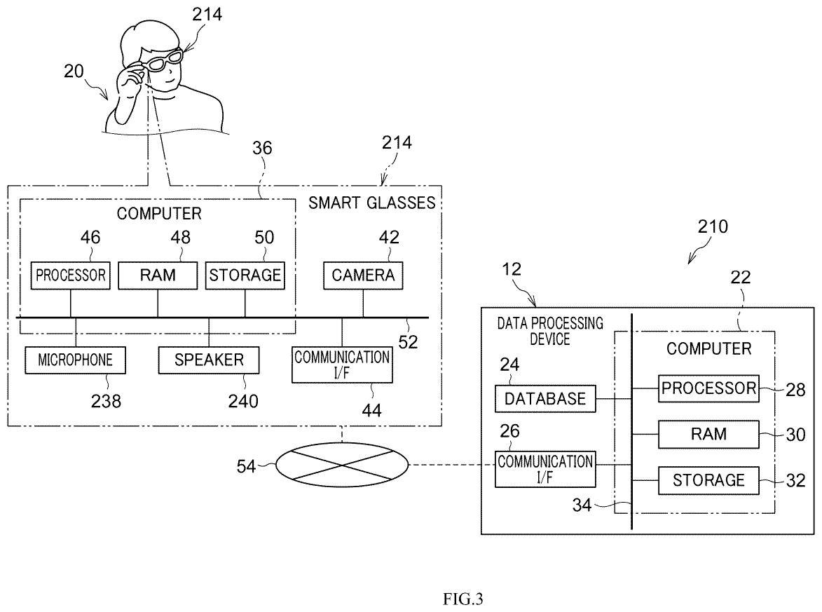

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

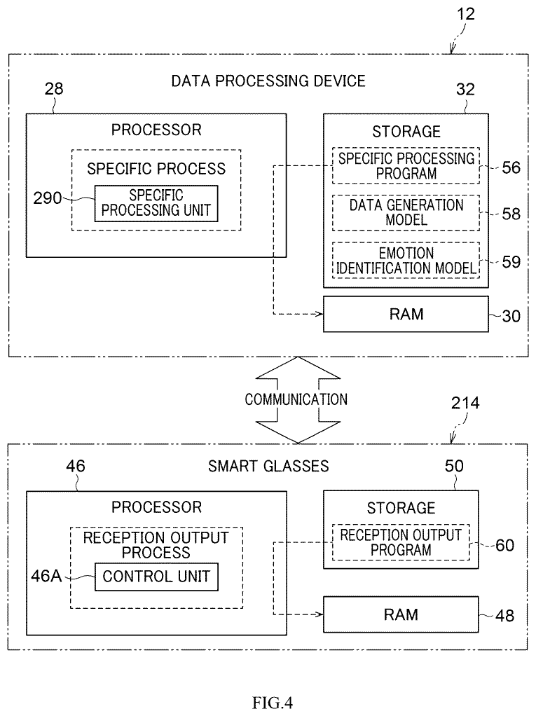

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

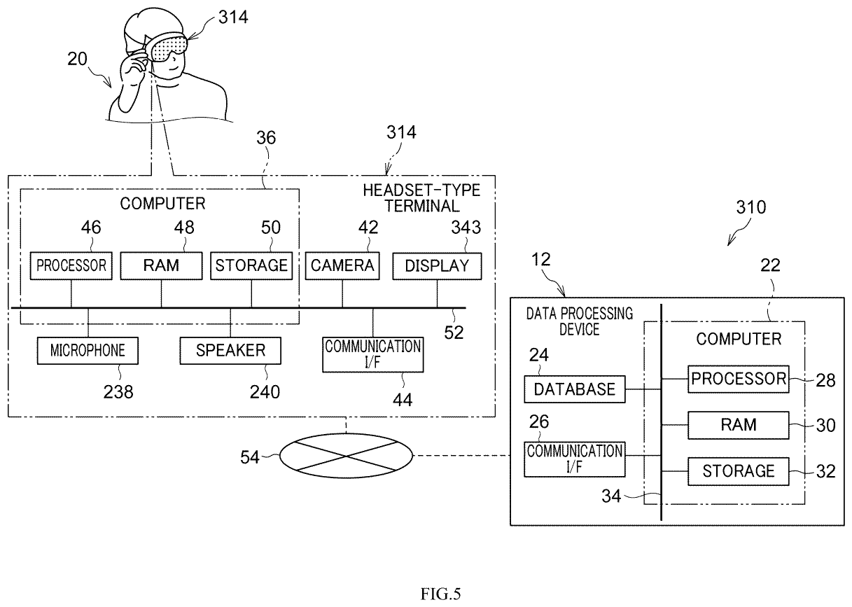

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

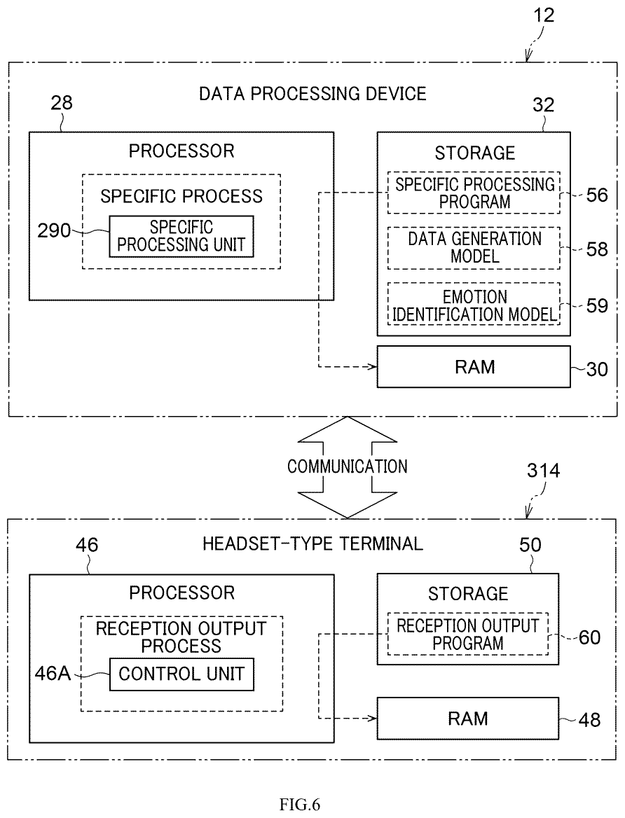

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

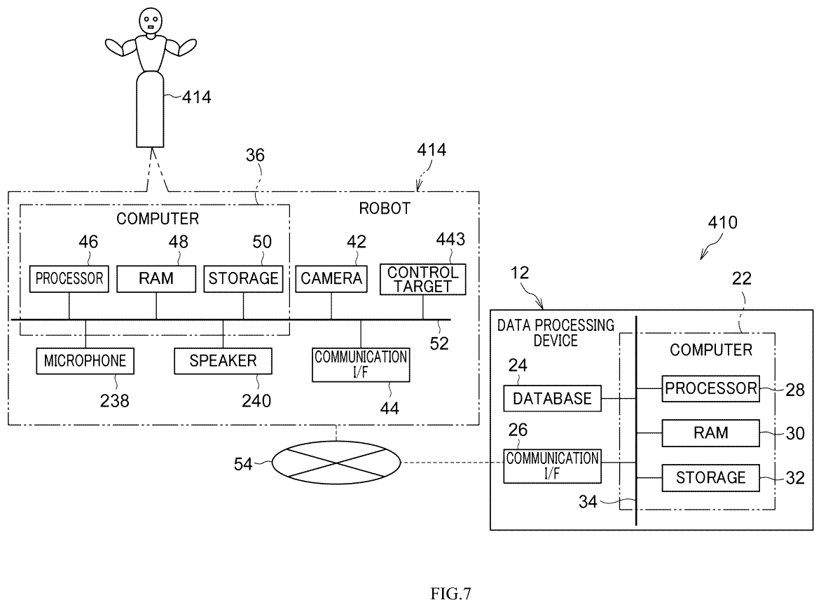

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

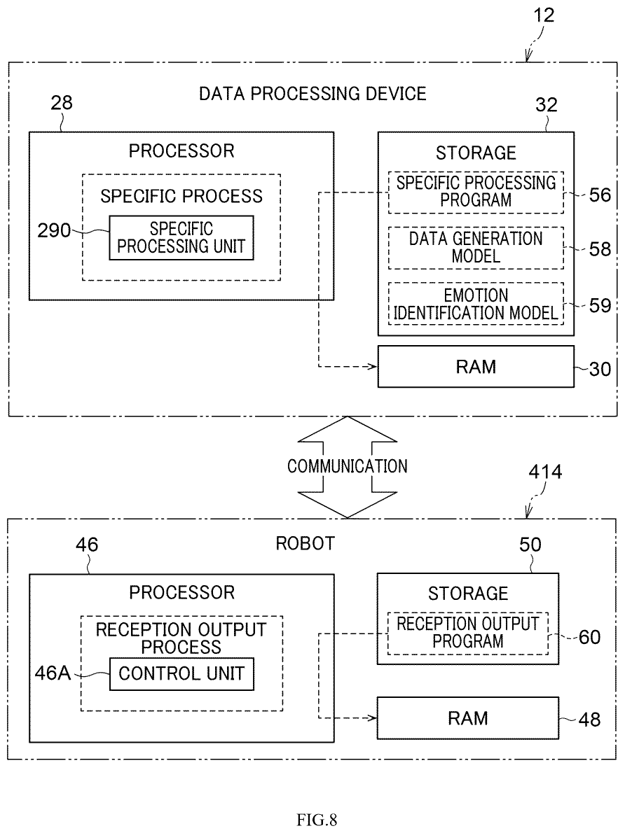

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

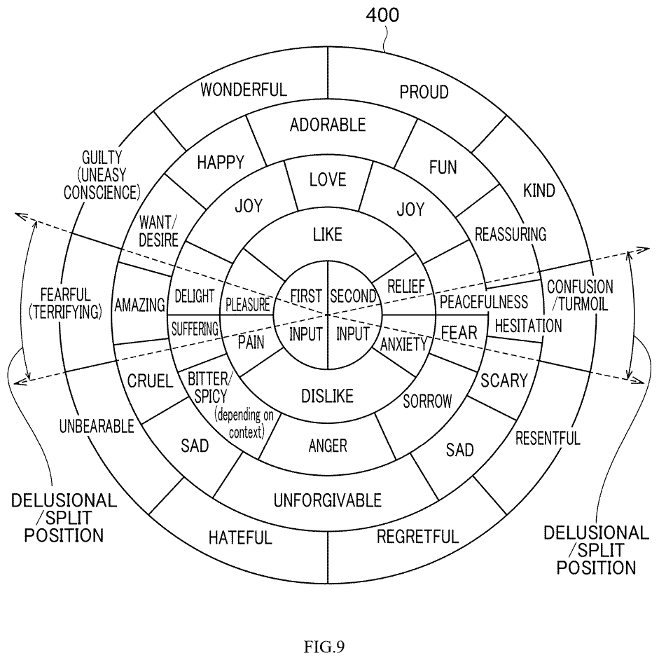

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

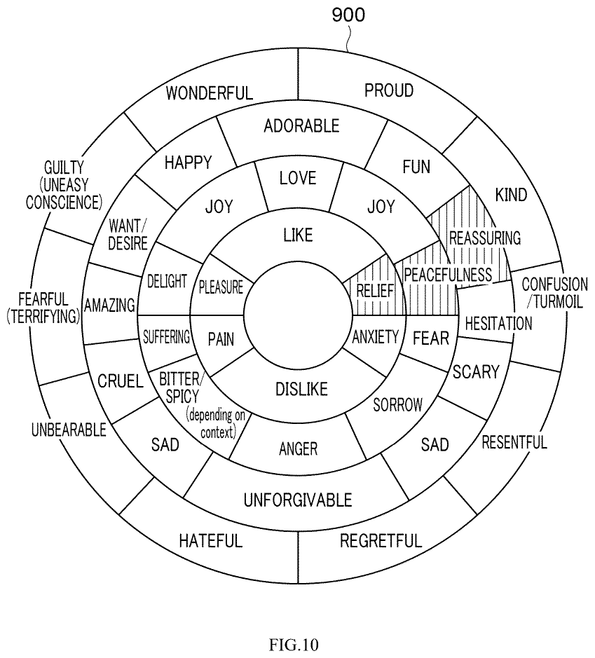

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC).

Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
perform data preprocessing on image information acquired from a monitoring device, analyze the preprocessed image information using a generative model mechanism to identify human actions or object states,
automatically determine abnormal states or out-of-standard operations based on the identification results,
generate information record data in a structured information format, the data including the determination results and work content,
register the information record data as a non-fungible digital asset on a cryptographically distributed ledger,
assign identifier information to the non-fungible digital asset and enable external terminals or information terminals to refer to it via electronic authentication, and
enable a user to acquire and display the non-fungible digital asset on an information terminal.

### Supplementary 2

The system according to supplementary 1,
wherein the processor is configured to detect abnormal states or process inconsistencies in a manufacturing process using the generative model mechanism and to perform real-time notification.

### Supplementary 3

The system according to supplementary 1,
wherein the processor is configured to make the non-fungible digital asset referable from external sources, the asset including supply source information, process information, and verification result information of an article.

### Application Example 1

### Supplementary 1

A system comprising a processor,
wherein the processor is configured to
analyze information data acquired from a monitoring apparatus by using a generative artificial intelligence model,
generate time-series information record data based on results analyzed by the generative artificial intelligence model,
generate electronic authentication information based on the time-series information record data,
provide the electronic authentication information to a user,
register the electronic authentication information in a distributed record management device,
analyze emotion information received from the user and generate management information using a result of analysis of the emotion information,
display the information data and the analysis results on a terminal device in real time, and
notify the terminal device in case of anomaly detection.

### Supplementary 2

The system according to supplementary 1,
wherein the processor is configured to
detect an abnormal state or malfunction in process flow by means of the generative artificial intelligence model.

### Supplementary 3

The system according to supplementary 1,
wherein the processor is configured to
include provenance information, process flow information, and quality control information of an article in the electronic authentication information.

### Example 2

### Supplementary 1

A system comprising a processor,
wherein the processor is configured to
preprocess image data obtained from a monitoring device,
analyze the preprocessed image data using a deep learning model,
generate process record information based on a result of the analysis by the deep learning model,
create and register a unique digital asset on a distributed ledger using the process record information,
provide the unique digital asset to a user via an information terminal,
analyze user evaluation information or emotion information by using natural language processing technology to determine a user satisfaction score, and
provide additional information or benefits to the user in accordance with the satisfaction score.

### Supplementary 2

The system according to supplementary 1,
wherein the processor is configured to automatically detect operational anomalies or errors in a manufacturing process using the deep learning model.

### Supplementary 3

The system according to supplementary 1,
wherein the unique digital asset includes production location information, manufacturing process information, and quality management information of a product.

### Application Example 2

### Supplementary 1

A system comprising a processor,
wherein the processor is configured to
perform preprocessing on measurement data acquired from an external device, analyze the preprocessed measurement data using a generative information processing model,
generate management information as time-series data based on the analysis result from the generative information processing model,
generate a uniquely identifiable electronic record based on the management information,
register the electronic record on a distributed ledger and provide it to a management target,
acquire and analyze behavioral information and emotional state of the management target, and
evaluate and record an evaluation value of the management target based on the acquired emotional information.

### Supplementary 2

The system according to supplementary 1,
wherein the processor is configured to detect state anomalies in a process by using the generative information processing model.

### Supplementary 3

The system according to supplementary 1,
wherein the electronic record includes generation location information of an article and process history information.

What is claimed is:

1. A system comprising a processor,
wherein the processor is configured to:
analyze video data acquired from a monitoring device by using a generation model;
generate a work log based on a result analyzed by the generation model;
generate a non-fungible token based on the work log; and
provide the non-fungible token to a user.

2. The system according to claim 1,
wherein the processor is further configured to detect errors or anomalies in a manufacturing process by the generation model.

3. The system according to claim 1,
wherein the non-fungible token includes product origin information and manufacturing process information.
